(19) United States
(12) Patent Application Publication
(10) Pub. No.: US 2015/0113018 A1
(43) Pub. Date: Apr. 23, 2015

(54) INTERACTIVE VISUAL ANALYTICS FOR SITUATIONAL AWARENESS OF SOCIAL MEDIA

(71) Applicant: UT Battelle, LLC, Oak Ridge, TN (US)

(72) Inventors: Chad A. Steed, Oak Ridge, TN (US); Robert M. Patton, Oak Ridge, TN (US); Paul L. Bogen, Oak Ridge, TN (US); Thomas E. Potok, Oak Ridge, TN (US); Christopher T. Symons, Oak Ridge, TN (US)

(21) Appl. No.: 14/476,252

(22) Filed: Sep. 3, 2014

Related U.S. Application Data
(60) Provisional application No. 61/892,169, filed on Oct. 17, 2013.

(51) Int. Cl. G06F 17/30; H04L 12/58

(52) U.S. Cl. CPC G06F 17/30539; H04L 51/04
USPC 707/776

(57) ABSTRACT

An adaptive system processes social media streams in real time. The adaptive system included a data management engine that generates combined data sets by detecting and mining a plurality of text-based messages from a social networking service on the Internet. An analytics engine in communication with the data management engine monitors topics in the text-based messages and tracks topic evolution contained in the text-based messages. A visualization engine in communication with the analytics engine renders historical and current activity associated with the plurality of text-based messages.

### BACKGROUND

1. Priority Claim.

This application claims the benefit of priority from U.S. Provisional Application No. 61/892,169 filed Oct. 17, 2013, under attorney docket number 13489/250, entitled “Interactive Visual Text Analytics for Situational Awareness of Social Media”, which is incorporated herein by reference.

2. Statement Regarding Federally Sponsored Research and Development.

The invention was made with United States government support under Contract No. DE-AO05-000R22725 awarded by the United States Department of Energy. The United States government has certain rights in the invention.

3. Technical Field.

This disclosure relates to an adaptive visual analytics system that detects and estimates sentiment, highlights change and trends, and identifies spatiotemporal patterns using a highly interactive information visualization interface within social media through a publicly accessible distributed network like the Internet.

4. Related Art.

Social media allows users to send and read textual messages. Collectively, such messages may identify and facilitate prominent events and social movements. The messages may reflect emotions that are associated with those events and social movements. Emotional states conveyed through these messages may reflect the importance of a situation, may identify a source of expertise, or may predict the start of a social movement.

The scale, velocity, and complexity of streaming messages from social media and other online feeds make state-of-the-art processing of these messages challenging. Current systems may not process messages at the rate the messages are transmitted from the social media source, may not scale to the social media's networks, and may restrict human interaction. In some systems the authenticity and integrity of the data is not assured and the systems do not support interactive analysis or automated analytics.

### BRIEF DESCRIPTION OF THE DRAWINGS

The patent or application file contains at least one drawing executed in color. Copies of this patent or patent application publication with color drawing(s) will be provided by the

Office upon request and payment of the necessary fee.

FIG. 1 is an adaptive system that analyzes social media streams.

FIG. 2 illustrates data management components.

FIG. 3 represents a process for decomposing text streams.

FIG. 4 is a graphical user display of an interactive canvass generated by the visualization engine.

FIG. 5 is a graphical user display of a total frequency view generated by the visualization engine.

FIG. 6 is a graphical user display of a geospatial view generated by the visualization engine.

FIG. 7 is a graphical user display using animated graphs to show the temporal frequency patterns in a text stream.

### DETAILED DESCRIPTION OF THE PREFERRED EMBODIMENTS

An adaptive system detects and interactively mines content transmitted across virtual and tangible networks to detect and estimate sentiment, highlight change, and identify spatiotemporal patterns from social media sources. The system processes streaming social media data and detects user communities by analyzing the textual content based on common terms and phrases. The system also estimates one or more user's personal positive and negative feelings or sentiments, and in some alternative systems, neutral feelings or sentiments. Through a real or near real-time analysis and classification of messages containing sentiments, the system may forecast the reactions of virtual communities to a given situation in real or near real-time especially when traditional media is unavailable. Through real time situational processing and forecast configurations, the system may rapidly detect and predict social movements and changes in response to complex or “intelligence hard” issues. A real-time operation comprises an operation matching a human's perception of time, which in a virtual environment is processed at the same rate (or perceived to be at the same rate) as a physical or an external process, such as processing data at the same rate the data is received from a source or alternatively a network or the time during which two computers maintain an interactive stateful information interchange, such as a dialogue or a conversation between two or more communicating devices (i.e., a session).

Through a visual analytics framework that enables interactive analysis of high-throughput text streams, the adaptive systems estimate sentiment, detect change and key associations, and automatically highlight spatiotemporal patterns in a virtual or social network. The hardware and/or software engines render visualizations on fixed or mobile device displays with real or near real-time data mining to render mixed-initiative tools that analyze dynamic streaming text. The spatiotemporal pattern shown in the visualization rendered on a display is based on registered and stored data sets retained in a local memory or a local or distributed database and memory. In the adaptive systems the spatiotemporal data is stored as objects, with longitude data, latitude data, and time data comprising three separate elements of a database record. In other storage schemes the database records store an identifier for a location or region and a time value as separate elements in a database record stored in a non-transitory memory.

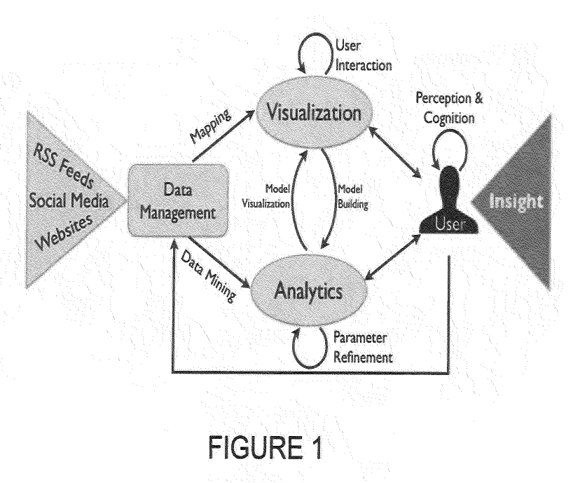

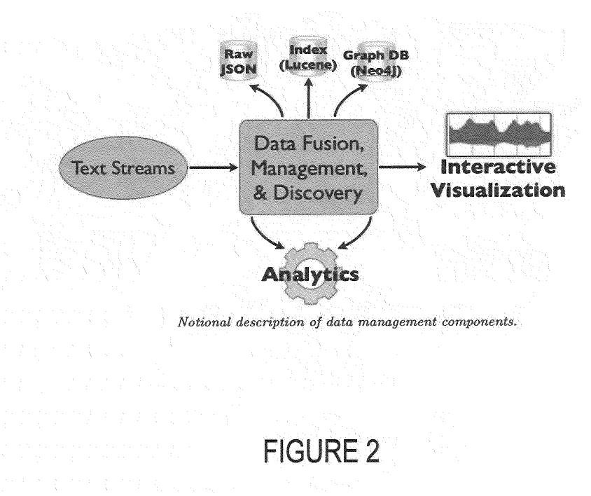

The adaptive system shown in FIG. 1 includes a data management framework that detects, samples, and mines raw text streams and stores the processed data in various database formats and indices through a data management engine represented as a gear in FIG. 2. The data management engine processes, stores, and transmits data to one or more analytic engines and visualization engines. An engine is one or more specially programmed processors executing application programs stored on a non-transitory medium that manages and manipulates data. Some adaptive systems continuously monitor, detect, sample, and to process streaming text from one or more on-line social networking services like Instagram, Twitter, etc., news feeds like RSS news feeds, visual social media platforms like YouTube or and/or microblogging services.

In FIGS. 1 and 2 the data management engine generates combined and/or associated data sets from multiple data sources so that the analytic engine renders and transmits inference and/or conclusion data based on analytical rules. Through data fusion the data management engine combines or associates data mined from the raw text streams sourced from a social media with other data rendered through automated filtered queries from alternative local or remote data sources. Some automated filtered queries are directed to specific geographic areas of interest or events and may include keywords that are used to gather additional information that is stored in one or more local, remote, or distributed intelligent databases. Intelligent databases manipulate the stored data in a way that is logical, natural, and easy to access through data finding application software routines and through predetermined database rules governing the associations, and relationships. And some intelligent databases manipulate the stored data based on inferences generated by an inference engine regarding the association of the data. The database structures are accessed by a database sublanguage (e.g., structured query language, for example) that is used for querying, updating, and managing database records stored in a local or distributed memory associated with the databases. The database is accessible through database engine or database server Application Program Interfaces (APIs) between the database and data management engine, analytics engine, and visualization engine that handles requests for database actions and controls database security and data integrity requirements.

The adaptive system also transforms the streaming content and fused data into a variety of data formats for analysis via the analytics engine and visualization through the visualization engine. Some adaptive systems read and write index files that are independent of a file format such as reading and writing Apache Lucene indices through the Lucene API (an open source project accessible at http://lucene.apache.org/), which may be configured to search across documents containing fields of text, including fields that may reflect the location and time of streamed content. Some adaptive systems automatically access libraries that provide access to a knowledge base (e.g., facts and rules that are executed to analyze the data in a specified domain) and store relationship data based on implicit networks that transmitted the data and/or social media sources. Some adaptive systems are configured to store information in a graph database, in relational databases, and/or document oriented (noSQL) databases or in a cloud. A cloud or cloud based computing refers to a scalable platform that provides a combination of services including computing, durable storage of both structured and unstructured data, network connectivity and other services. The metered services provided by a cloud or cloud based computing are interacted with (provisioned, de-provisioned, or otherwise controlled) via one or more of the engines such as the data management, analytics, and/or visualization engines.

The data management engine of FIG. 2 is configured to automatically build summary information for the streaming content in real or near real-time. The real or near real-time summaries may include temporal content, geospatial content, and/or textual context. For the temporal summaries, some adaptive systems calculate metrics and statistical measures (e.g., frequency, rate, variances, etc.) of the streaming content or objects for predetermined time intervals. Some adaptive systems store the number of objects received from the streaming content for a fixed time period (e.g., every second, minute, etc.), which is processed by the analytics engine and transmitted to the visualization engine to display visualization panels or windows that may display the statistical description of information flowing through the adaptive system.

The analytic engine that communicates with the data management engine in FIG. 1 accesses and executes a library of analytical application programs (e.g., tools) that are optimized for processing streaming content such as streaming text-based messages. Exemplary tools include programs that monitor topics, track topic evolution, and perform sentiment analysis.

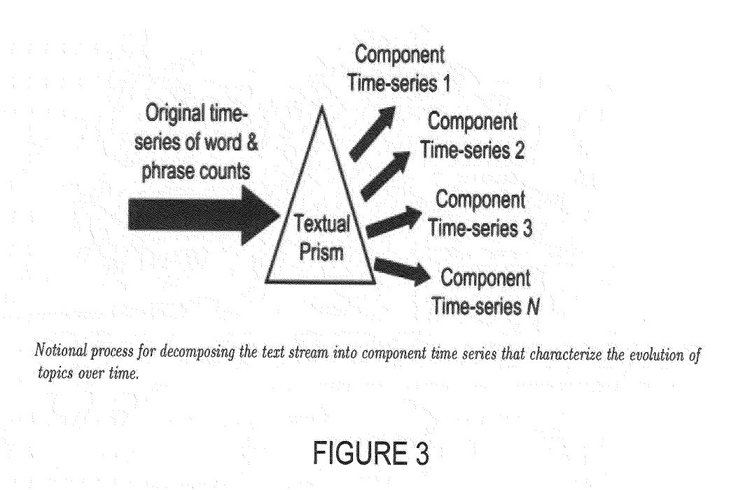

The words, phrases, and counts that are generated by the data management engine may be processed through a textual prism shown in FIG. 3 that is comprised of a set of taxonomies or through user defined vectors of words and phrases. The vectors may be applied to the text stream to render a number of component time series profiles that are stored in one or more databases records retained in a memory. The component time series captures how the words and phrases of the topic change over a predefined time period.

As new textual objects are received by the analytics engine, the new textual objects are analyzed to determine which topic(s) likely matches a component vector based on the predefined topics and pre-defined thresholds that may be programmed by a user and retained in memory. In FIG. 3, topics are visually represented by an array of terms and phrases that describe topics. For example, a weather topic may include terms like: tornado, hail, rain, wind, cloud, and sun.

When a new textual object is received by the analytics engine, the textual object may also be pre-processed by filtering out short functional words such as stop words (e.g., as, the, is a, an, etc.). Then, for each topic vector, the new text item vector is compared to the topic vector using a cosine similarity metric or by analyzing the intersection of the two vectors, for example. If the resulting value is greater than the user-defined threshold, the new object is assigned to the topic and may include an optional confidence score that represents the likelihood or probability of a correct designation to the topic vector. In the automated assigning or classification process, new textual objects may be assigned to multiple topic vectors. To monitor the topic evolution over time, the adaptive system counts the number of items for each topic for a predetermined time interval (e.g. minutes, hours, days) and a time-series data set is generated and stored in memory that may be further processed by the visualization engine and/or analytic engine.

The analytic engine of FIG. 1 automatically classifies the sentiment data mined from the streaming messages by classifying the messages as either positive or negative, and in alternative adaptive systems neutral. A process used for transforming raw text to a feature vector begins in some adaptive systems with converting all characters of the text-based message to a lower case. The analytic engine then remove all tokens beginning with the ‘@’ character. These tokens represent whom a posting is made on a social network like Twitter and carry no sentimental information. The analytic engine then filters the objects that include three or more of the same character positioned directly in a row by reducing the repeating characters to a predetermined number, such as two for the same character, for example. For example, the following post (or tweet if the social networking site is Twitter), comprised ‘Iiii looooveeee yoooouuuu’ the analytic engine converts the characters that comprise the object to ‘Ii loovee yoouu’. The replacement of characters repetitions of three or more characters may prevent tokens like the term ‘little’ from becoming the term ‘litle’. The analytic engine may next identify common contractions such as can't, won't, haven't, etc. and replace the common contractions with their longer or standard versions (e.g., cannot, will not, have not) of the contractions captured in the object. The analytics engine may then remove various bracketing characters (‘(’, ‘)’, ‘[’, and ‘]’) and compresses any extra whitespace contained within the object. The analytic engine then may remove address information such as URLs and replace it with a token address or token URL. Finally, the analytic engine removes any remaining punctuation. The processed string objects are then automatically segmented into tokens and stemmed using Porter's English stemmer, further filtered for stop words using a customized stop word list that preserves sentimental words like ‘want’, ‘not’, ‘should’, and ‘could,’ for example that maybe included in stop word lists. From these token lists the analytic engine generates a vector comprising tokens in the filtered input. Some analytic engines do not use counts as the short length of a post or tweet makes the re-occurrence of a token rare. Notable differences between the disclosed classification process executed by the analytics engine and described above and other processes is the analytic engine's discarding of ‘@’ tokens, expansion of contractions, use of a full stemmer, the customized stop word list, and the use of Boolean features as opposed to numeric features to name some of the differences. And, the analytic engine does not utilize bigrams. To train the analytic engines' classifier a publically available training set may be used. The training sets may be used to train a Python, Java Naive Bayes Classifier, and a Java Maximum Entropy Classifier. For Python the adaptive system may utilize nltk and Scikit-Learn. For Java the adaptive system may utilize MALLET and MinorThird.

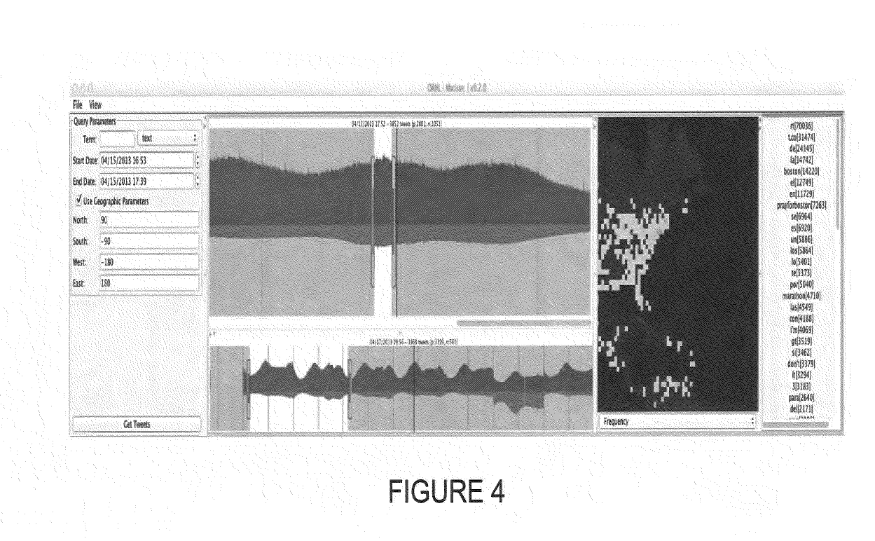

The adaptive system may render a highly interactive canvas or Window (see FIG. 4) through a graphical user interface (GUI) for graphically depicting the past (e.g., historical) and current state of activity in an active social media text stream. The adaptive system does so by providing temporal, geospatial, and textual views of data. The adaptive system generates common coordinated multiple view displays whereby changes in one display is linked and automatically propagated to the other displays proportionately to their display size and resolution, which is automatically stored in memory of the adaptive system. Furthermore, the visualization engine supports focused analysis processing in response to user queries and renders higher level contextual views customized to the user's request. Some of the views include textual views, geospatial views, and term views for example, that may be accessed and queried via an absolute or relative pointing device movement, such as a hover movement that renders a popup menu, via a physical movement of a pointing device such as a finger touching a screen, or in response to a voice command processed by a voice recognition system or eye movement processed by an eye or head tracker.

In a temporal view the adaptive system aggregates the summary statistics for some unit or interval of time (seconds, minutes, hours, etc.) to generate a time series that is stored in a memory or as a database record in memory. The time series may be encoded in a temporal visualization data set which may represent the summary metric through a two or three dimensional visualization. If a bar chart is used, for example, it may encode a single value over time or it can be shown through two displays showing a plurality of metrics such as two metrics. A GUI may show the overall frequency or rate of postings or tweets for a period of time. Alternatively, the view may show the frequency of positive sentiments on the top and the frequency of negative sentiments on the bottom, as shown in FIG. 4. In this display, the two bars may be summed to derive the overall frequency for the time unit.

In FIG. 4, two temporal views are shown. The bottom view is the overall summary of the selected measure over all time, with the blue shading representing positive sentiment and the orange shading represent the negative sentiment. In this view, the time series is rolled up and averaged by the visualization engine so the time duration covered by each bar is determined by the width of the display. The summary information is rolled up into higher order summaries by the visualization engine too. A user can select a region of time in the overview plot to view the detailed view in the top panel. In other words, the query is expressed by a user's interaction with the plot or map. In FIG. 4, the summary metrics are shown for the lowest level for a time period, in this case minutes. As shown, the visualization engine allows the user to select a range of time in this view and the geospatial and term view displays will be regenerated based on the selected items.

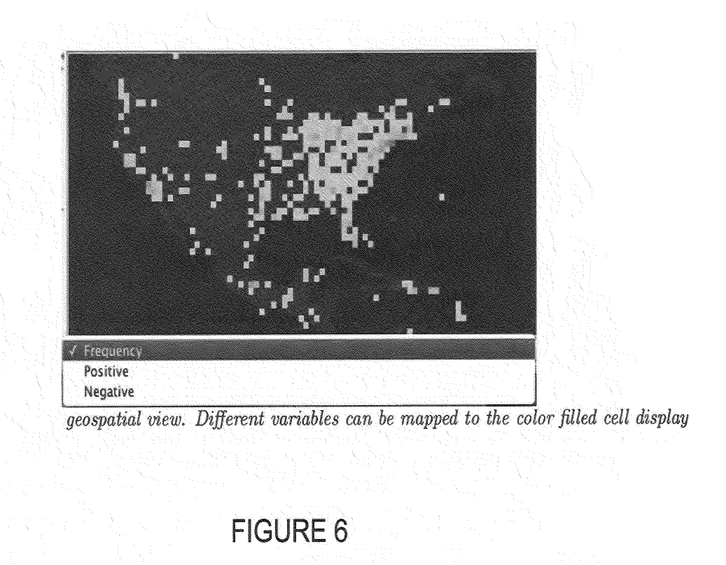

To the right of the temporal view in FIG. 4, the visualization engine renders a geospatial choropleth map of the selected time range (also shown in FIG. 6). The color scale used in the map represents grid cells with higher post or tweet counts as darker and more saturated shades of blue and lower post or tweet counts as lighter and less saturated shades of blue. Areas with higher message based activity are therefore, presented in a more visually salient manner to highlight relative activity.

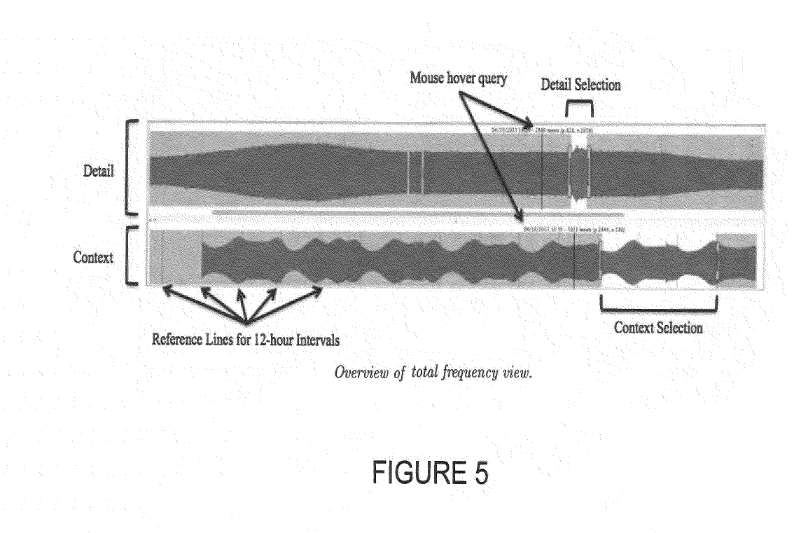

The geospatial choropleth map shown in FIGS. 4 and 6 renders the overall frequency, positive frequency, or negative frequency. Furthermore, additional derived statistical metrics are created and rendered in other alternative map views such as a total frequency view shown in FIG. 5. In these GUI displays, users can select a geospatial region in the map to program a spatial query referred to as an image querying for posts or tweets in a geographic area shown on the display. The maps may reflect the percentage of postings or tweets and include a geographical location based on the geographical information retained in metadata associated with the posts or tweets. Other maps may represent normalized values using population estimates when only a relative small percentage of posting or tweets include geospatial information. In some adaptive systems, the locations of the posts or tweets are derived from the text-messages of the postings or tweets in addition to the geospatial information provided by the source.

At right of the geospatial view of FIG. 4 is an exemplary term view that shows the top ranked terms for the selected time and spatial location of the posting. The top terms are calculated and stored in a summary file in a local or a remote memory for the time unit of interest (e.g., minutes, hours, days, years, etc.). To display the top terms for the selected time range, the visualization engine may access the top term summary information to publish the term view on the display.

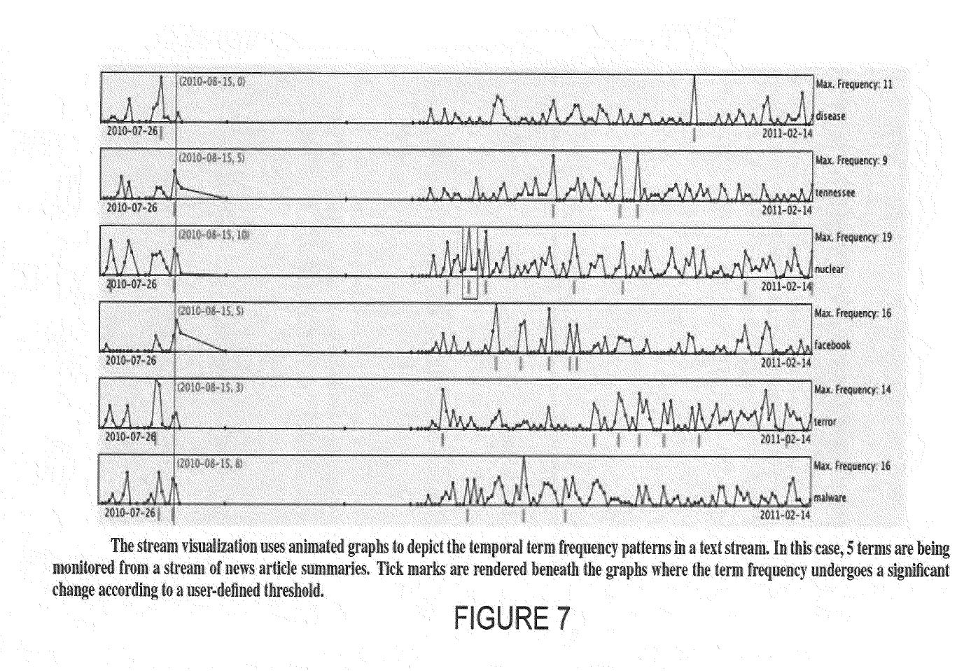

The graphs in FIG. 7 further show frequency visualization techniques that support interactive queries. The visualization technique also supports interactively browsing through the history of items for a time window of interest. In FIG. 7, the line graphs represent temporal term frequencies from a stream of news article summaries. The graph is supported by animation objects so that as new objects are processed, a new point or animation is appended to the line plot, and the plot is translated to the left by one time unit. The vertical red line that spans the graphs shown in FIG. 7 tracks the location of the pointing device to identify the frequency of term occurrences at the instant of time associated with the mouse or other pointing device location. The user can also use the pointing device to drag a focus object or rectangular selection in the display to query and/or view some or all associated data in the selected time range. Identifiers shown as tick marks beneath the graphs highlight significant changes in term's frequencies based on a user-defined threshold value. On the left-hand side of the graphs of FIG. 7, the term of interest and maximum frequency value are shown. This stream term frequency visualization may assist in the detection and investigation of short term atypical events as well as the discovery of longer term shifts in topical interest. This temporal stream visualization may be extended to encode additional impression characteristics or attributes of the data utilizing efficient data attribute to visual feature mappings such as connectedness, color, and shapes, to encode a large number of dimensions into a single display. These visualizations may be supplemented with additional information derived from or mined through the analytics engine so that significant associations and events may be highlighted to increase visual saliency of the image and improve the likelihood of highlighting relevant insight for the subject of interest.

As explained, various maps and views rendered by the visualization engine in the adaptive system may be linked whereby user selections made in the various parts of the displays are propagated automatically to the other maps and views rendered on the display or stored in a database record or memory. This coordinated multiple view model may be rendered and combined with a temporal focus and contextual focus display. The display may show the overview of the complete time series with a detailed view of the time unit of interest. In some geospatial maps, the view provides additional interactions for zooming in/out of a display, palming the viewpoint, and rendering of multi-dimensional displays (e.g., displays in three and four dimensions). Furthermore, the user may select words of interest in the term view to query specific text that includes the selected word(s). Selections in each of these windows or GUIs are used to program the filter/search criteria. Through Window selections, individual posts and tweets may be queried to see the general text used in posts or tweets and display aggregated statistics. The system may include various extensions, such as filtering for features and extensions that supplement the analytics and stream visualizations that may allow a user or system to analyze geographical changes in sentiment in real time. Some alternative systems assist in the analysis process by adapting the user interface using semi-supervised machine learning and pattern recognition. As the adaptive system tracks interactions through visualizations and graphical display widgets, the system may visually create and refine analytical questions that drive the parameters of the analytics algorithms. For example, given a clustering of items for a topic of interest, the user's interactions with the results are automatically recorded or programmed to label documents as relevant or irrelevant. These automatically labeled objects are examined programmatically to re-display the remaining unlabeled objects in a process that increases the prominence of potentially relevant objects, thereby increasing the likelihood of finding such information that may be hidden in obscure areas of a display.

The methods, devices, systems, and logic described above may be implemented in many other ways in many different combinations of hardware, software or both hardware and software and may be used to compare, contrast, and visually display objects. All or parts of the system may be executed through one or more controllers, one or more microprocessors (CPUs), one or more signal processors (SPU), one or more graphics processors (GPUs), one or more application specific integrated circuit (ASIC), one or more programmable media or any and all combinations of such hardware. All or part of the logic described above may be implemented as instructions for execution by a microcontroller that comprises electronics including input/output interfaces, a microprocessor, and an up-dateable memory comprising at least a random access memory which is capable of being updated via an electronic medium and which is capable of storing updated information, processors (e.g., CPUs, SPUs, and/or GPUs), controller, an integrated circuit that includes a microcontroller on a single chip or other processing devices and may be displayed through a display driver in communication with a remote or local display, or stored and accessible from a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, includes a specifically programmed storage medium and computer readable instructions stored on that medium, which when executed, cause the device to perform the specially programmed operations according to the descriptions above.

The adaptive systems may evaluate social media content shared and/or distributed among multiple users and system components, such as among multiple processors and memories (e.g., non-transient media), including multiple distributed processing systems. Parameters, databases, software, filters and data structures used to evaluate and analyze or pre-process the messages may be separately stored in memory and executed by the processors. It may be incorporated into a single memory block or within a database record stored in memory, or may be logically and/or physically organized in many different ways, and may be implemented in many ways. The programing executed by the adaptive systems may be parts (e.g., subroutines) of a single program, separate programs, application program or programs distributed across several memories and processor cores and/or processing nodes, or implemented in many different ways, such as in a library or a shared library accessed through a client server architecture across a private network or publicly accessible network like the Internet. The library may store detection and classification model software code that performs any of the system processing and classifications described herein. While various embodiments have been described, it will be apparent many more embodiments and implementations are possible through combinations of some or all of the systems and processes described herein.

The term “coupled” disclosed in this description encompasses both direct and indirect coupling. Thus, first and second parts are said to be coupled together when they directly contact one another, as well as when the first part couples to an intermediate part which couples either directly or via one or more additional intermediate parts to the second part. The term “sentiment” encompasses the emotional import of a passage or an object. It encompasses a view or attitude expressed in the passage encoded in a data set or an object both of which are based on an author's feeling or emotion instead of the author's reasoning. The term “substantially” or “about” encompasses a range that is largely, but not necessarily wholly, that which is specified. It encompasses all but an insignificant amount. When devices are responsive to commands events, and/or requests, the actions and/or steps of the devices, such as the operations that devices are performing, necessarily occur as a direct or indirect result of the preceding commands, events, actions, and/or requests. In other words, the operations occur as a result of the preceding operations. A device that is responsive to another requires more than an action (i.e., the device's response to) merely follow another action.

The term “spatiotemporal data” does not encompass all data, because the data may have been generated or transmitted at some point in time at some location. Here the term encompasses data that is stored and linked to stored data associated with longitude data, latitude data, and time data (measured seconds, minutes, or some finer resolution) as three of the elements of a record of a database, or data that is stored and linked to an identifier object for a geographic location or geographic region and time data (measured seconds, minutes, or some finer resolution) as two elements of a record of a database. The term “record” refers to a data structure that is a collection of multiple fields (elements) stored in a non-transitory media such as a nonvolatile memory, each with its own name field and data type that can be accessed as a collective unit. Unlike an array accessed using an index, the elements of a record represent different types of information that are accessed by name.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. An adaptive system that processes social media streams comprising:
a data management engine that generates combined data sets by detecting and mining a plurality of text-based messages from a social networking service on the Internet;
an analytics engine in communication with the data management engine that monitors topics and tracks topic evolution contained in the plurality of text-based messages; and
a visualization engine in communication with the analytics engine and is programmed to render historical and current activity of the plurality of text-based messages;
where the data management engine, the analytics engine, and the visualization engine comprise a plurality of specially programmed processor or non-transitory software stored on a computer readable media.

2. The system of claim 1 where the combined data sets are generated in near real-time with respect to the plurality of text-based messages received over the Internet.

3. The system of claim 1 where the combined data sets are generated by a data fusion that combine data mined from the plurality of text-based messages with other data rendered through remote queries to remote data sources.

4. The system of claim 1 where the combined data sets are stored in an intelligent database.

5. The system of claim 1 where the combined data sets are stored in a cloud accessible through the Internet

6. The system of claim 5 where the combined data sets are processed by a knowledge base that renders relationship data between the plurality of text-based messages with other data rendered and stored in a non-transitory memory through automated remote queries to remote data sources

7. The system of claim 1 where the data management engine is programmed to render summary information in real time about the plurality of text-based messages.

8. The system of claim 1 where the analytic engine classifies the plurality of text-based messages through a plurality of taxonomies.

9. The system of claim 1 where the analytic engine tracks topic evolution contained in the plurality of text-based messages in real time.

10. The system of claim 1 where the analytic engine classifies the plurality of text-based messages based on a plurality of sentiment objects.

11. The system of claim 1 where the sentiment comprises a user's personal positive feelings or negative feelings.

12. The system of claim 1 where the data management engine, the analytics engine, and the visualization engine comprise a specially programmed processor.

13. The system of claim 1 where the visualization engine renders a graphical user display in which a user can access multiple displays though an image query and changes in one display automatically propagates to all of a plurality of other displays associated with a displayed image without user intervention.

14. The system of claim 1 where the visualization engine renders a temporal view, a geospatial view, and a term view in a common Window on a display.

15. A programmable media comprising:
a graphical processing unit in communication with a memory element;
the graphical processing unit configured to detect and process a plurality of text-based messages transmitted from a social networking service on the Internet; and
the graphical processing unit further configured to automatically classify the plurality of text-based messages by classifying the sentiment in the plurality of text-based messages and transmitting data to a display that renders an interactive display comprising a temporal view, a geospatial view, and a term view of the plurality of text-based messages simultaneously in a display Window.

16. The system of claim 15 where the graphical processing unit configured to detect and process a plurality of text-based messages transmitted from a plurality of social networking service through the Internet.

17. The system of claim 15 where the graphical processing unit processes the text-based messages in real time.

18. A method of tracking sentiment in plurality of text-based messages transmitted through a publicly accessible distributed network, comprising:
detecting and processing a plurality of text-based messages transmitted from a social networking service on the Internet;
automatically classifying the plurality of text-based messages by classifying the sentiment in each of the plurality of text-based messages; and
rendering an interactive display comprising a temporal view, a geospatial view, and a term view of the plurality of text-based messages in a display Window.

19. The method of claim 18 where the processes of detecting, classifying, and rendering occurs in real time.

20. The programmable media of claim 18 where a graphical processing discriminates the text-based images based on sentiment contained in the plurality of text-based messages.
